(19) United States
(12) Patent Application Publication
(10) Pub. No.: US 2004/0105056 A1
(43) Pub. Date: Jun. 3, 2004

(54) Display device

(76) Inventors: Haruhisa Iida, Chiba (JP); Hideki Nakagawa, Chiba (JP); Iwao Takemoto, Mobara (JP); Takashi Sekimoto, Mobara (JP); Kazunari Saitou, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/720,103

(22) Filed: Nov. 25, 2003

(30) Foreign Application Priority Data
Nov. 29, 2002 (JP) 2002-346821

(51) Int. Cl. G02F 1/1335

(52) U.S. Cl. 349/113

(57) ABSTRACT

A liquid crystal display device can further enhance the display contrast. Reflection films are formed on pixel regions on a liquid-crystal-side surface of one substrate out of respective substrates which are arranged to face each other with liquid crystal therebetween. Light from another substrate side is incident on the reflection films through the liquid crystal and thereafter is reflected toward another substrate side. The formation of the reflection films is obviated in the vicinities of projecting portions formed in the pixel regions.

### BACKGROUND OF THE INVENTION

1. Field of the Invention

The present invention relates to a display device especially to a liquid crystal display device, and more particularly to a liquid crystal display device which is incorporated into a projector, for example.

2. Description of the Related Art

A liquid crystal display device is configured such that transparent substrates which are arranged to face each other with liquid crystal sandwiched therebetween constitute an envelope and a large number of pixels are provided in the spreading direction of the liquid crystal.

Each pixel includes a pair of electrodes and an optical transmissivity of the liquid crystal in the pixel is controlled by an electric field which is generated between these electrodes.

The liquid crystal display device which is incorporated into the projector is configured to transmit light from a light source through the liquid crystal display device and to enable a display of images which are obtained from respective pixels of the liquid crystal display device on a screen.

There exists a demand for further enhancement of contrast of the display with respect to the liquid crystal display device for projector. This is because the image displayed by the projector is displayed on a large screen and hence, a so-called presence is strongly demanded.

Here, as the liquid crystal display device, a so-called reflective-type liquid crystal display device has been known, wherein light from a light source is reflected on reflectors which also function as pixel electrodes of respective pixels so as to project images on a screen.

In this case, it has been confirmed that the light from the liquid crystal display device contains a reflection light from the vicinities of so-called spacers for ensuring a gap between a pair of transparent substrates, and the contrast of display is deteriorated due to the reflection-light. The uniformity of an orientation film is not sufficient in the vicinities of the spacers (referred to as domain regions) and these regions are recognized as leaking of light in a black display in a so-called normally white mode.

Here, this demand is not limited to the liquid crystal display device for projecting portion and a similar phenomenon occurs in the above-mentioned manner with respect to other usual liquid crystal display device having the reflective type constitution.

The present invention has been made in view of such circumstances and it is an object of the present invention to provide a liquid crystal display device which can enhance a display contrast.

### SUMMARY OF THE INVENTION

To briefly explain the summary of typical inventions out of the inventions disclosed in this specification, they are as follows.

Means 1.

In the liquid crystal display device according to the present invention which includes, for example, respective substrates which are arranged to face each other in an opposed manner with liquid crystal sandwiched therebetween, and reflection films which are formed on pixel regions on a liquid-crystal-side surface of one substrate out of the respective substrates so that light from another substrate side is incident on the reflection films through the liquid crystal and thereafter is reflected toward another substrate side, wherein

the formation of the reflection films is obviated in the vicinities of projecting portions which are formed in the pixel regions.

Means 2.

In the liquid crystal display device according to the present invention which includes, for example, respective substrates which are arranged to face each other in an opposed manner with liquid crystal sandwiched therebetween, and reflection films which are formed on pixel regions on a liquid-crystal-side surface of one substrate out of the respective substrates so that light from another substrate side is incident on the reflection films through the liquid crystal and thereafter is reflected toward another substrate side, wherein

the formation of the reflection films is obviated in peripheries of spacers which are formed in the pixel regions.

Means 3.

In the liquid crystal display device according to the present invention which includes, for example, respective substrates which are arranged to face each other in an opposed manner with liquid crystal sandwiched therebetween, and reflection films which are formed on pixel regions on a liquid-crystal-side surface of one substrate out of the respective substrates so that light from another substrate side is incident on the reflection films through the liquid crystal and thereafter is reflected toward another substrate side, wherein

the formation of the reflection films is obviated in peripheries of spacers formed in the pixel regions and in portions of the pixel regions except for portions which face a directing direction of rubbing on an orientation film which is brought into contact with the liquid crystal.

Means 4.

The liquid crystal display device according to the present invention is, for example, on the premise of the constitution of any one of means 1, 2 and 3, characterized in that the reflection films also functions as one electrodes which controls the optical transmissivity of the liquid crystal together with another electrodes formed on a liquid-crystal-side surface of another substrate.

Means 5.

The liquid crystal display device according to the present invention is, for example, on the premise of the constitution of any one of means 2, 3 and 4, characterized in that the reflection films are formed over the whole areas of the pixel regions except for the vicinities of the spacers.

Means 6.

The liquid crystal display device according to the present invention is, for example, on the premise of the constitution of any one of means 2, 3 and 4, characterized in that the reflection films are formed on one portions of the pixel regions except for the vicinities of the spacers and light transmitting electrodes which are electrically connected with the reflection films are formed in other portions of the pixel regions.

Means 7.

The liquid crystal display device according to the present invention is, for example, on the premise of the constitution of means 1, characterized in that switching elements which are operated in response to scanning signals from gate signal lines and supply video signals from drain signal lines to the reflection films are formed on the liquid-crystal-side surface of one substrate, and

the projecting portions are portions which are present on a surface which is brought into contact with liquid crystal due to the switching elements.

Means 8.

The liquid crystal display device according to the present invention is, for example, on the premise of the constitution of any one of means 2, 3, 5 and 6, characterized in that the spacers are formed of columnar spacers which are formed by selectively etching a material layer formed on a liquid-crystal-side surface of one substrate.

Means 9.

The liquid crystal display device of the present invention includes, for example, columnar spacers which are formed by selectively etching a material layer and an orientation film which is formed after the formation of the spacers on a liquid-crystal-side surface of one substrate out of respective substrates which are arranged to face each other in an opposed manner with liquid crystal sandwiched therebetween, wherein

a diameter of the spacers is set to a value equal to or less than 1.55 μm and a film thickness of the orientation film is set to a value equal to or less than 20 nm.

Here, the present invention is not limited to the above-mentioned constitutions and the constitutions of embodiments described later and various modifications are conceivable without departing from the technical concept of the present invention.

### BRIEF DESCRIPTION OF THE DRAWINGS

FIG. 1 is a plan view showing one embodiment of pixels of a liquid crystal display device according to the present invention;

FIG. 2 is an equivalent circuit diagram showing one embodiment of a liquid crystal display part of the liquid crystal display device according to the present invention;

FIG. 3 is a cross-sectional view showing one embodiment of the pixel of the liquid crystal display device according to the present invention;

FIG. 4 is a plan view showing another embodiment of the pixel of the liquid crystal display device according to the present invention;

FIG. 5 is a plan view showing another embodiment of the pixel of the liquid crystal display device according to the present invention; and

FIG. 6 is a cross-sectional view showing another embodiment of spacers and the vicinities thereof of the liquid crystal display device according to the present invention.

### DESCRIPTION OF THE PREFERRED EMBODIMENTS

Preferred embodiments of the present invention are explained in conjunction with drawings which show the embodiments.

Embodiment 1.

<<Equivalent Circuit>>

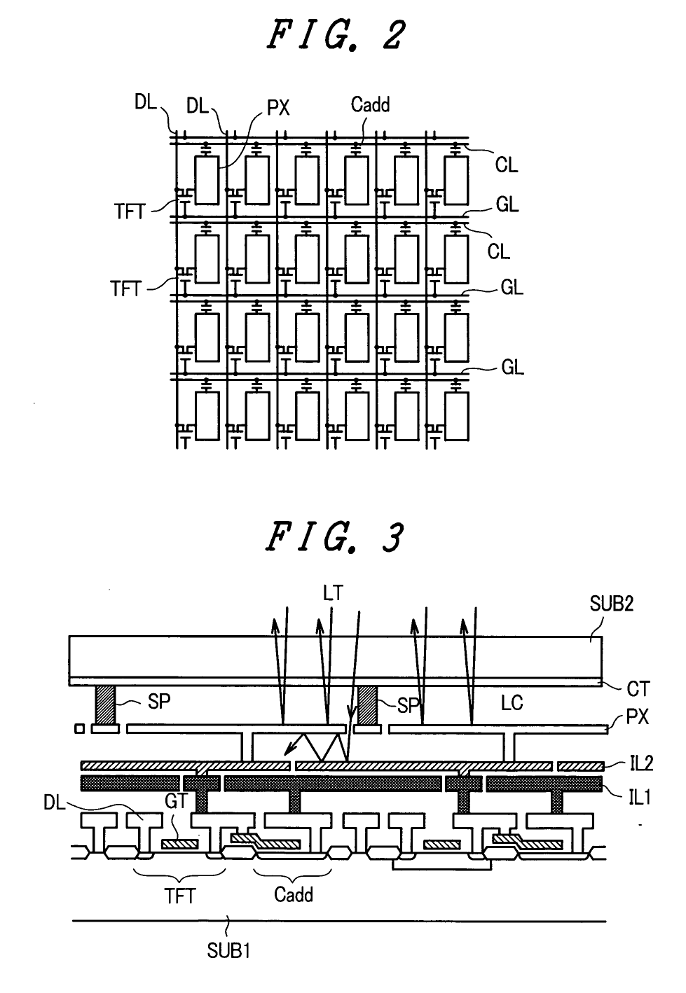

FIG. 2 shows an equivalent circuit on a liquid-crystal-side surface of one substrate out of respective substrates which are arranged to face each other with liquid crystal sandwiched therebetween. Although the drawing shows the equivalent circuit, the drawing is depicted corresponding to an actual geometric arrangement.

In the drawing, gate signal lines GL which extend in the x direction and are arranged in parallel in the y direction in the drawing are formed. Further, drain signal lines DL which extend in the y direction and are arranged in parallel in the x direction in the drawing are formed in a state that the drain signal lines DL are insulated from the respective gate signal lines GL.

Respective rectangular regions which are surrounded by these gate signal lines GL and drain signal line DL constitute pixel regions and a mass of these pixel regions constitutes a liquid crystal display part.

Further, each pixel region is provided with a thin film transistor TFT having the MIS (metal Insulator Semiconductor) structure and a gate electrode of the thin film transistor TFT is connected to the gate signal line GL arranged at a lower side in the drawing, for example.

Further, a drain electrode of the thin film transistor TFT is, for example, connected to the drain signal line DL at the left side in the drawing, while a source electrode of the thin film transistor TFT is connected to a pixel electrode PX.

That is, video signals from the drain signal line DL are supplied to the pixel electrode PX through the thin film transistor TFT which is turned on when scanning signals are supplied thereto from the gate signal line GL.

Further, this pixel electrode PX generates an electric field between the pixel electrode PX and a counter electrode not shown in the drawing which is formed in common with respective pixel regions formed on a liquid-crystal-side surface of another substrate, and the optical transmissivity of the liquid crystal between the respective electrodes is controlled due to the electric field.

With respect to the pixel electrode PX, a capacitive element Cadd is connected between the pixel electrode PX and a capacitive signal line CL which runs inside the pixel regions substantially in parallel to the gate signal line GL. The video signals supplied to the pixel electrodes PX can be stored for a relatively long time due to the provision of this capacitive element Cadd.

<<Constitution of Pixel>>

FIG. 3 is a cross-sectional view showing the constitution of the pixel in the above-mentioned pixel region. First of all, out of the respective substrates which are arranged to face each other with the liquid crystal therebetween, one substrate SUB1 is constituted of a silicon substrate. On the liquid-crystal-side surface of the substrate SUB1, by forming impurity diffusion layers, the source regions and the drain regions of the thin film transistors TFT and one electrode of the capacitive elements Cadd are formed.

Further, on a surface of the substrate SUB1 formed in this manner, a first insulation film is formed and the gate signal lines GL are formed on an upper surface of the first insulation film. In forming the gate signal lines GL, the gate electrodes GT of the thin film transistors TFT and another electrodes of the capacitive elements Cadd are formed.

In this case, the first insulation film functions as a gate insulation film in regions where the thin film transistors TFT are formed and functions as a dielectric film in regions where the capacitive elements Cadd are formed.

On the surface of the substrate SUB1 having such a constitution, a second insulation film is formed such that the second insulation film also covers the gate signal lines GL and the like and the drain signal lines DL are formed on an upper surface of the second insulation film. In forming the drain signal lines DL, the drain electrodes of the thin film transistors TFT which are electrically connected with the drain signal lines DL are formed. Further, the source electrodes, wiring layers which are connected with the source electrodes and the another electrodes of the capacitive elements Cadd and the like are also formed.

On the surface of the substrate SUB1 having such a constitution, a third insulation film is formed such that the third insulation film also covers the drains signal lines DL. On an upper surface of the third insulation film, a first light shielding film IL1 which also functions as a wiring layer is formed. The function of the first light shielding film IL1 as the wiring layer means to pull out the source electrodes of the thin film transistors TFT to this layer and to form one electrode of another capacitive elements which are formed in parallel to the above-mentioned capacitive elements Cadd.

On the surface of the substrate SUB1 having such a constitution, a fourth insulation film is formed such that the fourth insulation film also covers the first light shielding film IL1 and the like. On an upper surface of the fourth insulation film, a second light shielding film IL2 which also functions as a wiring layer is formed.

The second light shielding film IL2 is provided for ensuring the reliable light shielding in the pixel region together with the first light shielding film IL1. Particularly, the second light shielding film IL2 is formed such that the second light shielding film IL2 covers the region where the first light shielding film IL1 is not formed.

Here, the second light shielding film IL2 and the first light shielding film IL1 are electrically connected to each other and the source electrodes of the thin film transistors TFT are pulled out to this layer.

On the surface of the substrate SUB1 having such a constitution, a fifth insulation film is formed such that the fifth insulation film also covers the second light shielding film IL2 and the like. On an upper surface of the fifth insulation film, the pixel electrodes PX are formed.

Then, on upper surfaces of the pixel electrodes PX, spacers SP are formed so as to ensure a gap between the transparent substrate SUB1 and the transparent substrate SUB2 which is arranged to face the transparent substrate SUB1 with the liquid crystal LC therebetween. The spacers SP are formed on the liquid-crystal-side surface of the substrate SUB1 and are formed by selectively etching a material layer made of resin, for example, using a photolithography technique.

Here, although not shown in the drawing, after forming the spacers SP in this manner, an orientation film to which the rubbing treatment is applied is formed on the whole area of the upper surfaces of the pixel electrodes PX. The orientation film determines the initial orientation direction of molecules of the liquid crystal which is brought into direct contact with the orientation film.

The transparent substrate SUB2 is arranged to face the substrate SUB1 having such a constitution in an opposed manner with the liquid crystal sandwiched therebetween. On a liquid-crystal-side surface of the transparent substrate SUB2, a counter electrode CT is formed in common with respective pixel regions, wherein the counter electrode CT is formed of a light transmitting conductive film made of, for example, ITO (Indium Tin Oxide), ITZO (Indium Tin Zinc Oxide), IZO (Indium Zinc Oxide), SnO₂ (Tin Oxide), In₂O₃ (Yttrium Oxide) or the like. In this embodiment, the liquid crystal display device for projector is used as an object and hence, for example, black matrixes, color filters and the like are not formed on the liquid-crystal-side surface of the substrate SUB2.

In the liquid crystal display device having such a constitution, light LT is incident from the transparent substrate SUB2 side and this light passes through the liquid crystal whose optical transmissivity is controlled by the electric fields generated between the pixel electrodes PX and the counter electrodes CT, is reflected on the pixel electrodes PX formed of a reflection film and, then, is irradiated after passing through the transparent substrate SUB2.

<<Constitution of Pixel Electrode in the Vicinity of Spacer>>

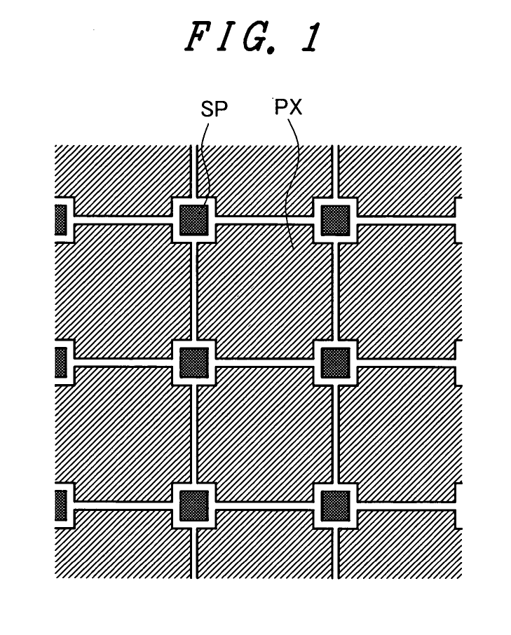

FIG. 1 is a plan view of the pixel electrodes PX in respective pixel regions as viewed from the transparent substrate SUB2 side.

The pixel electrode PX in each pixel region is formed over the whole area of the pixel region. This pixel electrode PX and the pixel electrode PX in another neighboring pixel region are electrically separated from each other with a slight gap therebetween over the drain signal line DL and the gate signal line GL.

On respective four corners of each pixel region having a rectangular shape, spacers SP are formed using corners of another neighboring pixel region as support bases.

Then, the pixel electrodes PX have regions where the pixel electrodes PX are not formed in the vicinities of the spacers SP. In these regions, the layer (fifth insulation film) which is positioned as a layer below the pixel electrodes PX is exposed.

In other words, in the periphery around each spacer SP, the region which obviates the formation of the pixel electrode PX of each pixel region is formed.

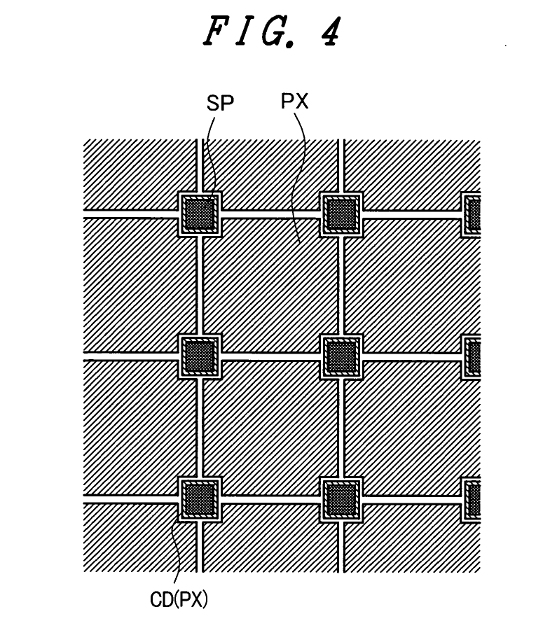

In this case, the formation of the pixel electrode PX can be obviated, as shown in FIG. 1, at the regions where the spacers SP are formed and the peripheries around the spacers SP. It is needless to say, however, as shown in FIG. 4, the formation of the pixel electrode PX can be obviated such that the spacers SP are formed on conductive layers CD (PX) made of the same material as the pixel electrodes PX and the peripheries of the conductive layers CD(PX) are removed. By adopting the constitution shown in FIG. 4, the conductive layers CD(PX) function as support bases for the spacers SP and hence, a height of the spacer SP can be reliably set equal to heights of other spacers SP.

<<Advantageous Effect>>

The liquid crystal display device having such a constitution is configured to remove the reflection films (pixel electrodes PX) present around the peripheries of the spacers SP and hence, an ambient light which is incident on these portions is not reflected. The peripheries of the spacers SP have no regularity with respect to the rubbing direction of the orientation film and constitute domain regions and hence, these portions are substantially prevented from constituting the pixel regions. Accordingly, when the liquid crystal display device is used in the normally white mode, it is possible to obviate leaking of light at these portions in the black display.

Here, by forming masks on these portions, it may be possible to provide the constitution which prevents the reflection of the incident ambient light in the same manner as this embodiment. In this case, however, it is impossible to obviate the increase of the number of manufacturing steps in the formation of the masks and the increase of areas of masks to consider the tolerance and the like due to misalignment of respective transparent substrates when the masks are formed on another transparent substrate side which faces one transparent substrate side.

By adopting the constitution of the above-mentioned embodiment, the increase of the manufacturing steps can be obviated and, at the same time, the removal of the reflection films around the spacers can be minimized and hence, the reduction of the numerical aperture can be suppressed to a minimum.

Embodiment 2.

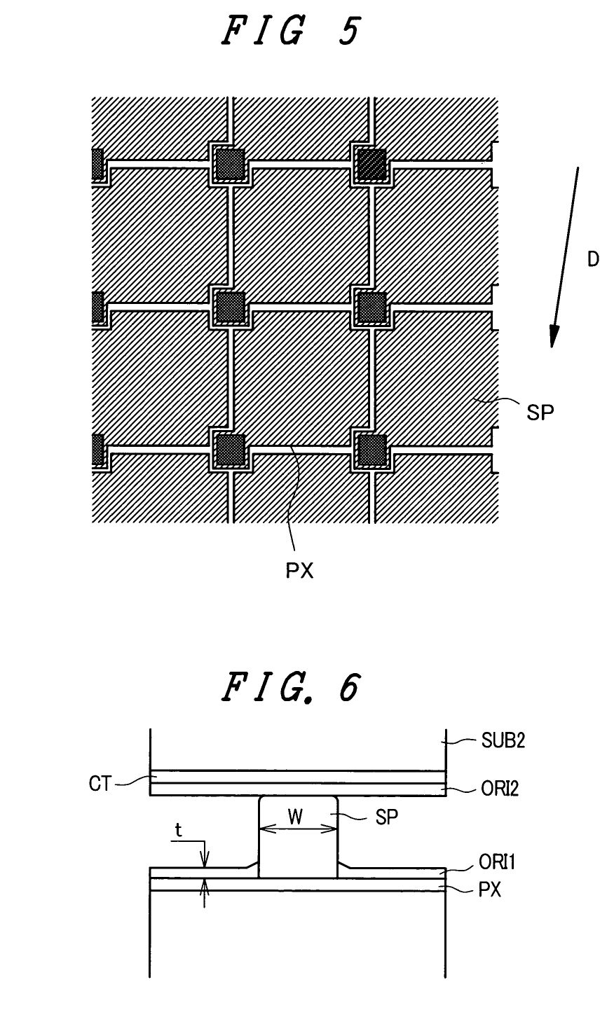

FIG. 5 is a plan view showing another embodiment of the liquid crystal display device according to the present invention and corresponds to FIG. 4.

The constitution which makes this embodiment different from the embodiment shown in FIG. 4 lies in that with respect to the periphery around each spacer SP, the reflection films (pixel electrodes PX) are not removed at portions which face the rubbing directing direction D of the orientation film at the substrate side on which the spacers SP are formed, while the reflection films on other portions are removed.

Out of the periphery of each spacer SP, the portions which face the rubbing directing direction of the orientation film are portions which do not constitute shades of the spacer at the time of performing the rubbing treatment and hence, the rubbing can be normally performed whereby the portions do not constitute the domain regions. Accordingly, the reflection films on these portions are left. That is, the portions are left as substantial portions of the pixel regions.

The liquid crystal display device having such a constitution can suppress the removal of the reflection films in the peripheries around the spacers SP to a minimum and hence, the numerical aperture of the pixels can be enhanced.

Embodiment 3.

FIG. 6 is a constitutional view showing another embodiment of the liquid crystal display device according to the present invention and is a cross-sectional view showing the above-mentioned spacer SP and the vicinity thereof.

In this embodiment, first of all, the spacer SP is formed such that the spacer SP has a diameter W of 1.55 μm and preferably less than this value.

Further, a film thickness t of an orientation film OR1 which is formed after formation of the spacer SP is set to 20 nm, and more preferably less than this value.

The liquid crystal display device having such a constitution can reduce so-called wetting finish with respect to the spacer SP on the orientation film ORI by setting the film thickness of the orientation film ORI to a small value. That is, it is possible to decrease the gradient of the wetting finish with respect to the spacers on the orientation film ORI.

Accordingly, in rubbing the orientation film ORI, it is possible to form the regions of the orientation film ORI having the reliable rubbing at positions extremely close to the spacer SP.

In this case, by setting the film thickness of the orientation film ORI to a small value, a voltage applied to the liquid crystal can be increased and hence, it is also possible to have an advantageous effect that the black luminance can be lowered, for example. This implies that the display contrast can be enhanced.

Further, by setting the diameter of the spacer SP to a small value, a diameter of the domain region about the spacer SP can be eventually made small and hence, the numerical aperture of the pixel can be enhanced.

The above-mentioned respective embodiments can be used in a single form or in combination. This is because the advantageous effects of the respective embodiments can be obtained in a single form or synergistically.

Further, it is needless to say that the present invention is not limited to the liquid crystal display device for projector and is applicable to other usual liquid crystal display device. This is because the further enhancement of the contrast can be obtained also with respect to the usual liquid crystal display device.

In this case, with respect to the usual liquid crystal display device, the black matrixes are formed on the liquid-crystal-side surface of another substrate. However, it is needless to say that the present invention is applicable to this case. This is because it is no more necessary to cover the peripheries of the spacers with the black matrix and hence, the task of the present invention can be solved without reducing the numerical aperture.

Further, with respect to the usual liquid crystal display device, it is needless to say that the present invention is also applicable to the reflective-type liquid crystal display device which is referred to as the partial transmissive liquid crystal display device. That is, this type of liquid crystal display device is configured such that, for example, the reflection films are formed on regions of the pixel regions except for the center portions and, at the same time, the light transmitting conductive films which are electrically connected with the reflection films are formed on the center portions, and the reflection films and the light transmitting conductive films constitute the pixel electrodes. The liquid crystal display device can be used in a divided form as the reflective type liquid crystal display device as well as the light transmissive type liquid crystal display device.

In this case, portions which differ from this embodiment lie in the presence of the light transmitting part in the pixel region and other portions have the substantially same constitution as this embodiment. Accordingly, the present invention is directly applicable to the regions where the reflective films are formed.

As can be clearly understood from the above-mentioned explanation, according to the liquid crystal display device according to the present invention, the further enhancement of the display contrast can be obtained.

What is claimed is:

1. A liquid crystal display device comprising respective substrates which are arranged to face each other in an opposed manner with liquid crystal sandwiched therebetween, and reflection films which are formed on pixel regions on a liquid-crystal-side surface of one substrate out of the respective substrates so that light from another substrate side is incident on the reflection films through the liquid crystal and thereafter is reflected toward another substrate side, wherein
the formation of the reflection films is obviated in the vicinities of projecting portions which are formed in the pixel regions.

2. A liquid crystal display device comprising respective substrates which are arranged to face each other in an opposed manner with liquid crystal sandwiched therebetween, and reflection films which are formed on pixel regions on a liquid-crystal-side surface of one substrate out of the respective substrates so that light from another substrate side is incident on the reflection films through the liquid crystal and thereafter is reflected toward another substrate side, wherein
the formation of the reflection films is obviated in peripheries of spacers which are formed in the pixel regions.

3. A liquid crystal display device comprising respective substrates which are arranged to face each other in an opposed manner with liquid crystal sandwiched therebetween, and reflection films which are formed on pixel regions on a liquid-crystal-side surface of one substrate out of the respective substrates so that light from another substrate side is incident on the reflection films through the liquid crystal and thereafter is reflected toward another substrate side, wherein
the formation of the reflection films is obviated in peripheries of spacers which are formed in the pixel regions and in portions of the pixel regions except for portions which face a directing direction of rubbing on an orientation film which is brought into contact with the liquid crystal.

4. A liquid crystal display device according to any one of claims 1, 2 and 3, wherein the reflection films also function as one electrode which control the optical transmissivity of liquid crystal together with another electrodes formed on a liquid-crystal-side surface of another substrate.

5. A liquid crystal display device according to any one of claims 2, 3 and 4, characterized in that the reflection films are formed over the whole areas of the pixel regions except for the vicinities of the spacers.

6. A liquid crystal display device according to any one of claims 2, 3 and 4, wherein the reflection films are formed on one portion of the pixel regions except for the vicinities of the spacers and light transmitting electrodes which are electrically connected with the reflection films are formed in other portions of the pixel regions.

7. A liquid crystal display device according to claim 1, wherein switching elements which are operated in response to scanning signals from gate signal lines and supply video signals from drain signal lines to the reflection films are formed on the liquid-crystal-side surface of one substrate, and
the projecting portions are portions which are present on a surface which is brought into contact with the liquid crystal due to the switching elements.

8. A liquid crystal display device according to any one of claims 2, 3, 5 and 6, wherein the spacers are formed of columnar spacers which are formed by selectively etching a material layer formed on a liquid-crystal-side surface of one substrate.

9. A liquid crystal display device comprising columnar spacers which are formed by selectively etching a material layer and an orientation film which is formed after the formation of the spacers on a liquid-crystal-side surface of one substrate out of respective substrates which are arranged to face each other in an opposed manner with liquid crystal sandwiched therebetween, wherein
a diameter of the spacers is set to a value equal to or less than 1.55 μm and a film thickness of the orientation film is set to a value equal to or less than 20 nm.
